(19) United States
(12) Patent Application Publication
(10) Pub. No.: US 2023/0220189 A1
(43) Pub. Date: Jul. 13, 2023

(54) RESIN COMPOSITION FOR SEALANT, MULTILAYERED BODY, PACKAGING MATERIAL AND PACKAGING CONTAINER

(71) Applicant: DOW-MITSUI POLYCHEMICALS CO., LTD., Tokyo (JP)

(72) Inventors: Takuya ISHIHARA, Ichihara-shi (JP); Koichiro YAMAMOTO, Ichihara-shi (JP); Hidenori HASHIMOTO, Ichihara-shi (JP)

(21) Appl. No.: 18/119,119

(22) Filed: Mar. 8, 2023

Related U.S. Application Data
(62) Division of application No. 17/432,297, filed on Aug. 19, 2021.

(30) Foreign Application Priority Data
Mar. 28, 2019 (JP) 2019-064698
Sep. 17, 2019 (JP) 2019-168513

(51) Int. Cl. C08L 31/04; B32B 27/36; C09K 3/10; B32B 27/32; B65D 65/40; B32B 27/08

(52) U.S. Cl. CPC C08L 31/04; B32B 27/36; C09K 3/10; B32B 27/32; B65D 65/40; B32B 27/08; B32B 2435/02; B32B 2307/31; C09K 2200/0622; C09K 2003/1084; C08L 2205/035; B32B 2439/40; C09K 2200/0617; C09K 2200/0632

(57) ABSTRACT

A resin composition for a sealant, comprising an ethylene/polar monomer copolymer (A), an adhesion-imparting resin (B) and a 4-methyl-1-pentene/α-olefin copolymer (C), a content of the 4-methyl-1-pentene/α-olefin copolymer (C) being from 1% by mass to 20% by mass with respect to a total mass of the resin composition for a sealant.

### TECHNICAL FIELD

The invention relates to a resin composition for a sealant, a multilayered body, a packaging material and a packaging container.

### BACKGROUND ART

Plastic containers having an easy-to-open lid are widely used as packaging containers for various kinds of foods and drinks, and medicines. The packaging material used for a sealant layer (seal layer) of the lid is required to be easy to open, in addition to having a wide range of heat seal temperatures and a stable peeling strength. Since a required degree of peeling strength varies depending on the material or purpose of the container, various types of packaging materials have been proposed and used.

Many kinds of packaging materials suitable for containers made of conventional materials such as polyolefin, polyvinyl chloride and polystyrene are already known (see, for example, Patent Document 1 and Patent Document 2).

### PRIOR ART DOCUMENTS

### Patent Documents

Patent Document 1: Japanese Examined Patent Application Laid-Open No. H05-6513
Patent Document 2: Japanese Patent Application Laid-Open No. H02-185547

### SUMMARY OF THE INVENTION

### Problem to be Solved by the Invention

However, as for containers made of an amorphous polyester, which are attracting attention recently as highly transparent containers, suitable packaging materials with favorable peeling properties in practical use are yet to be found. Specifically, it is difficult for conventionally proposed packaging materials to achieve both a sufficient degree of peeling strength and suppressed zipping (a phenomenon of creating a peeling sound and a slight vibration) upon peeling, with respect to an amorphous polyester.

In view of the aforementioned, the present disclosure aims to provide a resin composition for a sealant that exhibits an excellent peeling strength with respect to a substrate (especially an adhesion strength with respect to an amorphous polyester) and suppressed zipping upon peeling, i.e., excellent peeling properties, a multilayered body, a packaging material and a packaging container.

### Means for Solving the Problem

<1> A resin composition for a sealant, comprising an ethylene/polar monomer copolymer (A), an adhesion-imparting resin (B) and a 4-methyl-1-pentene/α-olefin copolymer (C), a content of the 4-methyl-1-pentene/α-olefin copolymer (C) being from 1% by mass to 20% by mass with respect to a total mass of the resin composition for a sealant.

<2> The resin composition for a sealant according to <1>, further comprising a styrene elastomer (D).

<3> The resin composition for a sealant according to <2>, wherein the styrene elastomer (D) comprises at least one selected from the group consisting of a styrene-ethylene/butylene block copolymer (SEB), a styrene-ethylene/butylene-styrene block copolymer (SEBS) and a styrene-ethylene/propylene-styrene block copolymer (SEPS).

<4> The resin composition for a sealant according to <2> or <3>, wherein a content of the styrene elastomer (D) is from 1% by mass to 15% by mass with respect to a total mass of the resin composition for a sealant.

<5> The resin composition for a sealant according to any one of <1> to <4>, wherein the 4-methyl-1-pentene/α-olefin copolymer (C) has a melting point of less than 110° C. or does not have a melting point.

<6> The resin composition for a sealant according to any one of <1> to <5>, wherein the ethylene/polar monomer copolymer (A) is an ethylene/vinyl acetate copolymer.

<7> The resin composition for a sealant according to any one of <1> to <6>, wherein the ethylene/polar monomer copolymer (A) has a content of structural units derived from vinyl acetate of from 1% by mass to 30% by mass.

<8> The resin composition for a sealant according to any one of <1> to <7>, wherein the resin composition for a sealant has a melt mass flow rate (JIS K7210-1999, 190° C., 2160 g load) of from 1 g/10 min to 100 g/10 min.

<9> A multilayered body, comprising a substrate and a sealant layer, the sealant layer comprising the resin composition for a sealant according to any one of <1> to <8>.

<10> A packaging material, comprising the multilayered body according to <9>.

<11> The packaging material according to <10>, which is a lid material.

<12> A packaging container, comprising a container main body having an opening and a lid that seals the opening, the lid being formed from the packaging material according to <11>.

<13> The packaging container according to <12>, wherein the container main body comprises an amorphous polyester.

### Effect of the Invention

According to the present disclosure, a resin composition for a sealant that exhibits an excellent peeling strength and excellent peeling properties with respect to a substrate, a multilayered body, a packaging material and a packaging container.

### EMBODIMENTS FOR IMPLEMENTING THE INVENTION

In the following, the embodiments of the present disclosure are explained. The explanation and the examples are intended for the exemplary illustration of the embodiments but not for the restriction of the embodiments.

In the present disclosure, a numerical range indicated using “to” includes the numerical values before and after “to” as a minimum value and a maximum value, respectively.

In numerical ranges stated in a stepwise manner in the present disclosure, the upper limit value or the lower limit value stated in one numerical range may be replaced with the upper limit value or the lower limit value of another numerical range stated in a stepwise manner. Further, in the numerical range stated in the present disclosure, the upper limit value or the lower limit value of the numerical range may be replaced with the value shown in the examples.

—Resin Composition for Sealant—

The resin composition for a sealant according to the present disclosure includes an ethylene/polar monomer copolymer (A), an adhesion-imparting resin (B) and a 4-methyl-1-pentene/α-olefin copolymer (C), and a content of the 4-methyl-1-pentene/α-olefin copolymer (C) is from 1% by mass to 20% by mass with respect to a total mass of the resin composition for a sealant.

The resin composition for a sealant according to the invention includes a 4-methyl-1-pentene/α-olefin copolymer (C), having excellent stress relaxation properties, in addition to an ethylene/polar monomer copolymer (A) and an adhesion-imparting resin (B). This is thought to be a reason that the resin composition for a sealant according to the invention exhibits excellent peel strength and peeling properties with respect to a substrate, even when it is used as a packaging material, for example.

<<Characteristics of Resin Composition for Sealant>>

The melt mass flow rate (hereinafter, also referred to as MFR, 190° C., 2160 g load) of the resin composition for a sealant is preferably from 1 g/10 min to 100 g/10 min, more preferably from 5 g/10 min to 50 g/10 min, further preferably from 8 g/10 min to 30 g/10 min, particularly preferably from 10 g/10 min to 30 g/10 min, from the viewpoint of further improvements in the peeling strength and the peeling properties with respect to a substrate.

The MFR of the resin composition for a sealant is a value measured by a method according to JIS K7210-1999 under the temperature and the load as specified above.

The method for controlling the MFR of the resin composition for a sealant to be within the above range is not particularly limited, and examples thereof include adjusting the composition ratio of an ethylene/polar monomer copolymer (A), an adhesion-imparting resin (B) and a 4-methyl-1-pentene/α-olefin copolymer (C) as described later.

<<Ethylene/Polar Monomer Copolymer (A)>>

The resin composition for a sealant according to the present disclosure includes an ethylene/polar monomer copolymer (A).

The resin composition for a sealant may include a single kind of the ethylene/polar monomer copolymer (A), or may include two or more kinds thereof.

The ethylene/polar monomer copolymer (A) is a binary copolymer or a multicomponent copolymer of ethylene and a polar monomer. The ethylene/polar monomer copolymer may be a copolymer of ethylene and a single kind of polar monomer, or may be a copolymer of ethylene and two or more kinds of polar monomer.

The content of the structural units derived from the polar monomer in the ethylene/polar monomer copolymer (A) is preferably from 1% by mass to 30% by mass, more preferably from 2% by mass to 30% by mass, further preferably from 3% by mass to 30% by mass, with respect to the total structural units, from the viewpoint of further improvements in the peeling strength and the peeling properties with respect to a substrate.

When the resin composition for a sealant includes two or more kinds of ethylene/polar monomer copolymer (A) having structural units of the same kind but different composition ratios, the total content of the polar monomer in the copolymers is preferably within the above range.

When the resin composition for a sealant includes a styrene elastomer (D) as described later, the content of the structural units derived from the polar monomer (especially vinyl acetate) in the ethylene/polar monomer copolymer (A) with respect to the total structural units is preferably from 1% by mass to 30% by mass, more preferably from 2% by mass to 30% by mass, further preferably from 3% by mass to 30% by mass, yet further preferably from 5% by mass to 30% by mass, particularly preferably 5% by mass to 26% by mass, most preferably from 5% by mass to 15% by mass, from the viewpoint of further improvements in the peeling strength and the peeling properties with respect to a substrate.

Examples of the polar monomer includes a vinyl ester such as vinyl acetate; unsaturated carboxylic acid ester such as methyl acrylate, ethyl acrylate, isobutyl acrylate, n-butyl acrylate, isooctyl acrylate and methyl methacrylate; unsaturated carboxylic acid, such as acrylic acid, methacrylic acid and maleic acid anhydride; and carbon monoxide. Among them, the polar monomer is preferably a vinyl ester, more preferably vinyl acetate. Namely, the ethylene/polar monomer copolymer (A) is preferably an ethylene/vinyl ester copolymer, more preferably an ethylene/vinyl acetate copolymer.

The content of the structural units derived from vinyl acetate (hereinafter, also referred to as the content of vinyl acetate unit) in the ethylene/polar monomer copolymer (A) is preferably from 1% by mass to 30% by mass, more preferably from 5% by mass to 30% by mass, with respect to the total structural units.

When the content of the vinyl acetate unit is 1% by mass or more, the peel strength with respect to a substrate of the resin composition for a sealant tends to be more favorable.

When the content of the vinyl acetate unit is 30% by mass or less, the peel strength and the peeling properties with respect to a substrate of the resin composition for a sealant tend to be more favorable.

The ethylene/polar monomer copolymer (A) preferably has a melt mass flow rate (MFR) at 190° C. and 2160 g load of from 1 g/10 min to 15 g/10 min, more preferably from 2 g/10 min to 10 g/10 min, from the viewpoint of improving the processability and the adhesion strength by heat sealing.

When the melt mass flow rate is 1 g/10 min or more, the adhesion strength by heat sealing tends to be more favorable. When the melt mass flow rate is 15 g/10 min or less, the processability tends to be favorable.

When the resin composition for a sealant includes two or more kinds of ethylene/polar monomer copolymer (A), the mixture thereof preferably has a melt flow rate within the above range.

The melt mass flow rate of the ethylene/polar monomer copolymer is a value measured by a method according to JIS K7210-1999 under the temperature and the load as specified above.

The content of the ethylene/polar monomer copolymer (A) with respect to the total mass of the resin composition for a sealant is preferably 10% by mass or more, more preferably 20% by mass or more, further preferably 50% by mass or more, particularly preferably 60% by mass or more, from the viewpoint of further improvement in the peeling strength. The content of the ethylene/polar monomer copolymer (A) with respect to the total mass of the resin composition for a sealant is preferably 80% by mass or less, from the viewpoint of the processability.

The content of the structural units derived from the polar monomer (vinyl acetate) in the ethylene/polar monomer copolymer (A) with respect to the total mass of the resin composition for a sealant is preferably from 0.1% by mass to 24% by mass, more preferably from 1% by mass to 20% by mass, further preferably from 5% by mass to 20% by mass.

When the content of the structural units derived from the polar monomer (vinyl acetate) is 0.1% by mass or more, the resin composition for a sealant tends to exhibit more favorable peeling strength with respect to a substrate.

When the content of the structural units derived from the polar monomer (vinyl acetate) is 24% by mass or less, the resin composition for a sealant tends to exhibit more favorable processability.

<<Adhesion-Imparting Resin (B)>>

The resin composition for a sealant according to the present disclosure includes an adhesion-imparting resin (B).

The resin composition for a sealant may include a single kind of the adhesion-imparting resin (B), or may include two or more kinds thereof.

Examples of the adhesion-imparting resin (B) include an aliphatic hydrocarbon resin, an alicyclic hydrocarbon resin, an aromatic hydrocarbon resin, a styrene resin, a terpene resin, and rosins.

Examples of the aliphatic hydrocarbon resin include a polymer obtained from a monomer raw material containing a C₄-C₅ monoolefin or diolefin such as 1-butene, isobutylene, butadiene, 1,3-pentadiene, isoprene or piperylene as a principal component.

Examples of the alicyclic hydrocarbon resin include a resin obtained by polymerizing a product obtained by cyclization and dimerization of a diene component in a spent C₄-C₅ fraction; a resin obtained by polymerizing a cyclic monomer such as cyclopentadiene; and a resin obtained by nuclear hydrogenation of an aromatic hydrocarbon resin.

Examples of the aromatic hydrocarbon resin include a polymer obtained from a monomer raw material containing a C₉-C₁₀ vinyl aromatic hydrocarbon monomer such as vinyl toluene, indene or α-methyl styrene as a principal component.

Examples of the styrene resin include a polymer obtained from a monomer raw material containing styrene, vinyl toluene, α-methyl styrene, isopropenyl toluene or the like as a principal component.

Examples of the terpene resin include an α-pinene polymer, a β-pinene polymer, a dipentene polymer, a terpene-phenol copolymer, an α-pinene/phenol copolymer and a hydrogenated terpene resin.

Examples of the rosins include rosin, polymerized rosin, hydrogenated rosin, rosin ester, a rosin-modified phenol resin, and an ester of a rosin-modified phenol resin.

The adhesion-imparting resin is preferably an alicyclic hydrocarbon resin, an aliphatic hydrocarbon resin or a terpene resin (especially hydrogenated terpene), more preferably an alicyclic hydrocarbon resin.

The adhesion-imparting resin preferably has a softening point measured by a ring-and-ball method of from 70° C. to 150° C., more preferably from 100° C. to 130° C.

The softening point measure by a ring-and-ball method is a value measured by a method according to JIS K6863 (1994).

The content of the adhesion-imparting resin (B) with respect to the total mass of the resin composition for a sealant is preferably 3% by mass or more, from the viewpoint of further improvement in the peel strength.

The content of the adhesion-imparting resin (B) with respect to the total mass of the resin composition for a sealant is preferably 35% by mass or less, more preferably 30% by mass or less, from the viewpoint of the processability.

<<4-Methyl-1-Pentene/α-Olefin Copolymer (C)>>

The resin composition for a sealant according to the present disclosure includes a 4-methyl-1-pentene/α-olefin copolymer (C).

The resin composition for a sealant may include a single kind of the 4-methyl-1-pentene/α-olefin copolymer (C), or may include two or more kinds thereof.

The 4-methyl-1-pentene/α-olefin copolymer (C) is a copolymer including structural units derived from 4-methyl-1-pentene and structural units derived from an α-olefin (other than 4-methyl-1-pentene, hereinafter the same applies).

The 4-methyl-1-pentene/α-olefin copolymer (C) preferably includes structural units derived from 4-methyl-1-pentene in an amount of from 15% by mole to 75% by mole with respect to the total structural units, more preferably from 20% by mole to 75% by mole, further preferably from 60% by mole to 75% by mole, from the viewpoint of the peel strength and the peeling properties with respect to a substrate.

The 4-methyl-1-pentene/α-olefin copolymer (C) preferably includes structural units derived from an α-olefin in an amount of from 25% by mole to 85% by mole with respect to the total structural units, more preferably from 25% by mole to 80% by mole, further preferably from 25% by mole to 40% by mole.

It is possible to use a single kind of α-olefin or two or more kinds thereof. When two or more kinds of α-olefin are used, the total amount of the structural units derived from the two or more kinds of α-olefin preferably satisfies the above range.

The total amount of the structural units derived from 4-methyl-1-pentene and the structural units derived from an α-olefin is preferably 100% by mole.

It is possible to control the 4-methyl-1-pentene/α-olefin copolymer (C) to have a melting point (Tm) measured by differential scanning calorimetry (DSC) of lower than 110° C., or not to have a melting point (Tm), by adjusting the proportions of the structural units derived from 4-methyl-1-pentene and the structural units derived from an α-olefin to be within the above ranges, respectively.

The 4-methyl-1-pentene/α-olefin copolymer (C) may be a block copolymer or a random copolymer. From the viewpoint of transparency and processability, the 4-methyl-1-pentene/α-olefin copolymer (C) is preferably a random copolymer.

The α-olefin preferably has 2 to 20 carbon atoms. Preferred examples of the α-olefin having 2 to 20 carbon atoms include ethylene, propylene, 1-butene, 1-pentene, 1-hexene, 3-methyl-1-butene, 3-methyl-1-pentene, 1-octene, 1-decene, 1-dodecene, 1-tetradecene, 1-hexadecene, 1-heptadecene, 1-octadecene and 1-eicosene.

From the viewpoint of copolymerizability and the properties of the obtained copolymer (such as stress relaxation properties), the α-olefin having 2 to 20 carbon atoms is preferably ethylene, propylene, 1-butene, 1-hexene, 3-methyl-1-butene, 3-methyl-1-pentene, 1-octene, 1-decene, 1-hexadecene, 1-heptadecene or 1-octadecene; more preferably ethylene, propylene, 1-butene, 1-hexene, 1-octene, 1-decene, 1-hexadecene, 1-heptadecene or 1-octadecene; further preferably ethylene, propylene, 1-butene, 1-octene, 1-decene, 1-hexadecene, 1-heptadecene or 1-octadecene. Among these, an α-olefin having 2 to 4 carbon atoms is preferred, and specific examples thereof include ethylene, propylene and 1-butene.

From the viewpoint of improving the copolymerizability and the dispersibility, the α-olefin having 2 to 20 carbon atoms is preferably propylene.

The 4-methyl-1-pentene/α-olefin copolymer (C) may include structural units derived from a polymerizable compound other than 4-methyl-1-pentene or an α-olefin having 2 to 20 carbon atoms (hereinafter, also referred to as a polymerizable compound).

Examples of the polymerizable compound include vinyl compounds having a cyclic structure such as styrene, vinylcyclopentene, vinylcyclohexane and vinylnorbornane; vinyl esters such as vinyl acetate; unsaturated organic acids or derivatives thereof such as maleic acid anhydride; conjugated dienes such as butadiene, isoprene, pentadiene and 2,3-dimethylbutadiene; and non-conjugated polyenes such as 1,4-hexadiene, 1,6-octadiene, 2-methyl-1,5-hexadiene, 6-methyl-1,5-heptadiene, 7-methyl-1,6-octadiene, dicyclopentadiene, cyclohexadiene, dicyclooctadiene, methylenenorbornene, 5-vinylnorbornene, 5-ethylidene-2-norbornene, 5-methylene-2-norbornene, 5-isopropylidene-2-norbornene, 6-chloromethyl-5-isopropenyl-2-norbornene, 2,3-diisopropylidene-5-norbornene, 2-ethylidene-3-isopropylidene-5-norbornene and 2-propenyl-2,2-norbornadiene.

The 4-methyl-1-pentene/α-olefin copolymer (C) may include structural units derived from the polymerizable compound as described above in an amount of 10% by mole or less, or 5% by mole or less, or 3% by mole or less, with respect to the total structural units of all polymerizable compounds included in the 4-methyl-1-pentene/α-olefin copolymer (C).

(Loss Tangent Tan δ)

The 4-methyl-1-pentene/α-olefin copolymer (C) preferably has a maximum value of loss tangent (tan δ) in a range of from −40° C. to 150° C. measured by dynamic viscoelastic measurement at a frequency of 1.6 Hz and a temperature elevation rate of 2° C./min (hereinafter, also referred to as a tan δ peak value) of from 1.0 to 5.0, more preferably from 1.5 to 5.0, further preferably from 2.0 to 4.0, from the viewpoint of improving the peeling properties with respect to a substrate.

The conditions for measuring the tan δ peak value of the 4-methyl-1-pentene/α-olefin copolymer (C) are as follows.

A press sheet with a thickness of 3 mm is prepared from the 4-methyl-1-pentene/α-olefin copolymer (C) by applying a pressure of 10 MPa with a hydraulic heat press machine (Shinto Metal Industries Corporation) heated at 190° C., and a test piece having a size of 45 mm×10 mm×3 mm for the measurement is obtained from the press sheet.

The temperature dependency of dynamic viscoelasticity in a temperature range of from −40° C. to 180° C. of the test piece is measured with a viscoelastometer (MCR 301, AntonPaar) at a frequency of 1.6 Hz and a temperature elevation rate of 2° C./min, and the temperature at which a loss tangent (tan δ) derived from a glass transition temperature is maximum (hereinafter, also referred to as a peak temperature) and the value of the loss tangent (tan δ) are measured.

The temperature at which the loss tangent (tan δ) is maximum (peak temperature) is not particularly limited, and may be from −40° C. to 80° C., preferably from 0° C. to 50° C., more preferably from 10° C. to 40° C., for example.

The method for controlling the maximum value of loss tangent (tan δ) of the 4-methyl-1-pentene/α-olefin copolymer (C) is not particularly limited, and examples thereof include adjusting the composition ratio of structural units derived from 4-methyl-1-pentene and structural units derived from an α-olefin.

(Limiting Viscosity)

The 4-methyl-1-pentene/α-olefin copolymer (C) preferably has a limiting viscosity [η] measured in 135° C. decalin of from 0.5 dL/g to 5.0 dL/g, more preferably from 1.0 dL/g to 4.0 dL/g, further preferably from 1.2 dL/g to 3.5 dL/g.

The value of the limiting viscosity [11] can be adjusted by the amount of hydrogen added in a polymerization process to obtain the 4-methyl-1-pentene/α-olefin copolymer (C).

When the limiting viscosity [η] is within the above range, the resin composition for a sealant tends to exhibit a favorable flowability in a process of production or molding of the resin composition for a sealant. Further, dispersibility of the 4-methyl-1-pentene/α-olefin copolymer (C) with respect to the ethylene/polar monomer copolymer (A) tends to improve.

The limiting viscosity [η] of the 4-methyl-1-pentene/α-olefin copolymer (C) can be measured by the following method.

Approximately 20 mg of the 4-methyl-1-pentene/α-olefin copolymer (C) are dissolved in 25 ml of decalin, and a specific viscosity (ηsp) of the decalin solution is measured with an Ubbelohde viscometer in an oil bath at 135° C. The decalin solution is diluted by adding 5 ml of decalin, and a specific viscosity (ηsp) of the diluted decalin solution is measured in the same manner as the above. The dilution is performed twice more, and the value of ηsp/C, obtained by extrapolating the concentration (C) to zero, is determined as the limiting viscosity [η] (unit: dL/g).

(Molecular weight distribution (Mw/Mn))

The 4-methyl-1-pentene/α-olefin copolymer (C) preferably has a molecular weight distribution (Mw/Mn), which is a ratio of the weight average molecular weight (Mw) to the number average molecular weight (Mn) measured by gel permeation chromatography (GPC), of from 1.0 to 3.5, more preferably from 1.0 to 3.0, further preferably from 1.5 to 2.5.

The molecular weight distribution (Mw/Mn) can be adjusted by, for example, selecting the type of a catalyst for olefin polymerization as described later.

The resin composition for a sealant including a 4-methyl-1-pentene/α-olefin copolymer (C) having a molecular weight distribution (Mw/Mn) within the above range tends to include a smaller amount of relatively low-molecular components, and the bleed out thereof is suppressed. Further, when pellets or films are produced from a resin composition for a sealant including a 4-methyl-1-pentene/α-olefin copolymer (C), occurrence of blocking tend to be suppressed and film properties (especially mechanical properties) tend to be favorable.

The molecular weight distribution (Mw/Mn), which is a ratio of the weight average molecular weight (Mw) to the number average molecular weight (Mn), of the 4-methyl-1-pentene/α-olefin copolymer (C) can be measured by a standard polystyrene equivalent method by performing gel permeation chromatography (GPC) under the following conditions.

Measurement device: GPC (ALC/GPC 150-C plus-type, integrated with differential refractometer, Waters)

Columns: GMH6-HT (Tosoh Corporation)×2 and GMH6-HTL (Tosoh Corporation)×2, serially connected

Eluent: o-dichlorobenzene

Column temperature: 140° C.

Flow rate: 1.0 mL/min

(Density)

The 4-methyl-1-pentene/α-olefin copolymer (C) preferably has a density of from 825 kg/m³ to 860 kg/m³, more preferably from 830 kg/m³ to 855 kg/m³, further preferably from 830 kg/m³ to 850 kg/m³, particularly preferably from 830 kg/m³ to 845 kg/m³.

The value of the density can be adjusted by the type or the amount of an α-olefin to be copolymerized with 4-methyl-1-pentene.

When the density of the 4-methyl-1-pentene/α-olefin copolymer (C) is within the above range, the resin composition for a sealant tends to exhibit favorable heat resistance and have an advantage in weight saving.

The density of 4-methyl-1-pentene/α-olefin copolymer (C) is a value measured by a method according to JIS K7112 (density-gradient tube method).

(MFR)

The 4-methyl-1-pentene/α-olefin copolymer (C) preferably has a melt mass flow rate of from 0.01 g/10 min to 100 g/10 min, more preferably from 0.5 g/10 min to 50 g/10 min, further preferably from 0.5 g/10 min to 30 g/10 min, from the viewpoint of flowability during processing and further improving the peel strength and the peeling properties with respect to a substrate.

The melt mass flow rate (MFR) of the 4-methyl-1-pentene/α-olefin copolymer (C) is a value measured by a method according to ASTM D1238 at 230° C. and 2.16 kg load.

The method for adjusting the melt mass flow rate (MFR) of the 4-methyl-1-pentene/α-olefin copolymer (C) to be within the above range is not particularly limited, and examples thereof include adjusting the composition ratio of structural units derived from 4-methyl-1-pentene and structural units derived from an α-olefin.

(Melting Point)

The 4-methyl-1-pentene/α-olefin copolymer (C) preferably has a melting point (Tm) measured by differential scanning calorimetry (DSC) of less than 110° C. or does not have a melting point, more preferably has a melting point of less than 85° C. or does not have a melting point.

The resin composition for a sealant including a 4-methyl-1-pentene/α-olefin copolymer (C) that has a melting point (Tm) of less than 110° C. or does not have a melting point tends to exhibit excellent processability.

The melting point (Tm) of the 4-methyl-1-pentene/α-olefin copolymer (C) can be measured by differential scanning calorimetry according to the following method.

Approximately 5 mg of the 4-methyl-1-pentene/α-olefin copolymer (C) are placed in an aluminum pan of a differential scanning calorimeter (DSC220C, Seiko Instruments Inc.) and sealed, and the temperature is increased from room temperature (23° C.) to 200° C. at a rate of 10° C./min. The temperature is maintained at 200° C. for 5 minutes in order to allow the 4-methyl-1-pentene/α-olefin copolymer (C) to melt completely, and cooled down to −50° C. at a rate of 10° C./min. After maintaining the temperature at −50° C. for 5 minutes, a second heating up to 200° C. is performed at a rate of 10° C./min. A peak temperature (° C.) detected in the second heating is determined as the melting point (Tm) of the 4-methyl-1-pentene/α-olefin copolymer (C). When a melting peak is not detected in a range of from −50° C. to 200° C. in the second heating, it is determined that the 4-methyl-1-pentene/α-olefin copolymer (C) does not have a melting point. When more than one peaks are detected, a peak at the highest temperature is determined as the melting point (Tm) of the 4-methyl-1-pentene/α-olefin copolymer (C).

Examples of the method for obtaining a 4-methyl-1-pentene/α-olefin copolymer (C) not having a melting point or having a melting point within the above range include a method of adjusting the stereoregularity of the 4-methyl-1-pentene/α-olefin copolymer (C) using a catalyst for olefin polymerization; and a method of adjusting the content of structural units derived from an α-olefin in the 4-methyl-1-pentene/α-olefin copolymer (C).

(Synthesis)

The 4-methyl-1-pentene/α-olefin copolymer (C) may be obtained as a commercial product or may be synthesized. The 4-methyl-1-pentene/α-olefin copolymer (C) can be synthesized by, for example, polymerizing 4-methyl-1-pentene and an α-olefin as mentioned above, and optionally other polymerizable compounds as mentioned above, under the presence of a catalyst for olefin polymerization.

Examples of a catalyst for olefin polymerization include a metallocene catalyst.

Preferred examples of the metallocene catalyst include those described in International Publication No. 01/53369, International Publication No. 01/27124, JP-A No. H03-193796, JP-A No. H02-41303, International Publication No. 06/025540 and International Publication No. 2014/050817.

The content of the 4-methyl-1-pentene/α-olefin copolymer (C) with respect to the total mass of the resin composition for a sealant is from 1% by mass to 20% by mass, preferably from 3% by mass to 16% by mass, more preferably from 3.5% by mass to 16% by mass, further preferably from 4% by mass to 16% by mass.

When the resin composition for a sealant includes a styrene elastomer (D) as described later, the content of the 4-methyl-1-pentene/α-olefin copolymer (C) with respect to the total mass of the resin composition for a sealant is from 1% by mass to 20% by mass, preferably from 6% by mass to 14% by mass, more preferably from 7% by mass to 12% by mass.

When the content of the 4-methyl-1-pentene/α-olefin copolymer (C) with respect to the total mass of the resin composition for a sealant is 1% by mass or more, the resin composition for a sealant tends to exhibit more favorable peeling properties.

When the content of the 4-methyl-1-pentene/α-olefin copolymer (C) with respect to the total mass of the resin composition for a sealant is 20% by mass or less, the resin composition for a sealant tends to exhibit more favorable peel strength.

<<Styrene Elastomer (D)>>

The resin composition for a sealant may include a styrene elastomer (D).

The resin composition for a sealant may include a single kind of the styrene elastomer (D), or may include two or more kinds thereof.

The styrene elastomer (D) is a block copolymer having a soft segment formed of a diene block (diene polymer) and a hard segment formed of a styrene block (styrene polymer). The block copolymer may be a hydrogenated product.

Specific examples of the block copolymer and hydrogenated products thereof include a styrene-butadiene block copolymer (SB), a styrene-butadiene-styrene block copolymer (SBS), a styrene-isoprene block copolymer (SI), a styrene-isoprene-styrene block copolymer (SIS), and hydrogenated products thereof.

A hydrogenated product of a block copolymer may be a block copolymer in which all of the styrene block and the diene block are hydrogenated, a block copolymer in which only the diene block is hydrogenated, or a block copolymer in which a part of the styrene block and a part of the diene block are hydrogenated (partially hydrogenated product).

Among the block copolymers and hydrogenated products thereof, a styrene-ethylene/butylene block copolymer (SEB), which is a hydrogenated product of a styrene-butadiene block copolymer (SB), a styrene-ethylene/butylene-styrene block copolymer (SEBS), which is a hydrogenated product of styrene-butadiene-styrene block copolymer (SBS), and a styrene-ethylene/propylene-styrene block copolymer (SEPS), which is a hydrogenated product of a styrene-isoprene-styrene block copolymer (SIS) are preferred from the viewpoint of thermal stability during injection molding, stability during processing, suppressed amount of deteriorated products generated, and suppressed amount of odor.

Among these, a styrene-ethylene/butylene-styrene block copolymer (SEBS) and a styrene-ethylene/propylene-styrene block copolymer (SEPS) are more preferred, and a styrene-ethylene/butylene-styrene block copolymer (SEBS) is further preferred.

The styrene elastomer (D) may be an acid-modified styrene elastomer, which is a styrene elastomer subjected to graft modification with at least one compound selected from an unsaturated carboxylic acid and a derivative of an unsaturated carboxylic acid.

Examples of the unsaturated carboxylic acid include acrylic acid, methacrylic acid, 2-ethyl acrylic acid, crotonic acid, maleic acid, fumaric acid and itaconic acid. Among these, the unsaturated carboxylic acid is preferably at least one selected from acrylic acid, methacrylic acid, maleic acid, fumaric acid and itaconic acid, more preferably maleic acid, from the viewpoint of production efficiency of the acid-modified styrene elastomer and sanitary reasons.

Examples of the derivative of an unsaturated carboxylic acid include anhydrides such as maleic acid anhydride, phthalic acid anhydride and itaconic acid anhydride, acid esters such as monomethyl maleate and monoethyl maleate, acid amides, and acid halides. Among these, maleic acid anhydride is preferred.

It is possible to use a single kind of an unsaturated carboxylic acid or a derivative thereof, or may use two or more kinds thereof.

It is possible to use an acid-modified styrene elastomer obtained by grafting, into a styrene elastomer, at least one compound selected from an unsaturated carboxylic acid and a derivative of unsaturated carboxylic acid under the presence of a radical initiator in a melted state. It is possible to use a radical initiator that is commonly used for a graft reaction of polyolefin.

The acid value of the acid-modified styrene elastomer is preferably greater than 0 mgCH₃ONa/g and less than 20 mgCH₃ONa/g, more preferably greater than 0 mgCH₃ONa/g and less than 11 mgCH₃ONa/g, further preferably from 0.5 mgCH₃ONa/g to 11 mgCH₃ONa/g.

The MFR (melt flow rate; according to ASTM D-1238, 190° C., 2160 g load) is not particularly limited, and is generally from 0.1 g/10 min to 100 g/10 min, preferably from 0.5 g/10 min to 50 g/10 min.

The content of the styrene elastomer (D) with respect to the total mass of the resin composition for a sealant is preferably from 1% by mass to 15% by mass, more preferably from 2% by mass to 10% by mass, further preferably from 2% by mass to 8% by mass.

When the content of the styrene elastomer (D) with respect to the total mass of the resin composition for a sealant is 1% by mass or more, the resin composition for a sealant tends to exhibit more favorable peel strength with respect to a substrate.

When the content of the styrene elastomer (D) with respect to the total mass of the resin composition for a sealant is 15% by mass or less, the resin composition for a sealant tends to exhibit more favorable peeling properties with respect to a substrate.

<<Other Components>>

The resin composition for a sealant according to the disclosure may include other components than the components as described above.

Examples of the other components include an additive such as an antioxidant, a thermal stabilizer, a light stabilizer, an antistat, a lubricant, a colorant, a slip agent and a releasing agent, preferably a slip agent and a releasing agent.

The content of the additive with respect to the total mass of the resin component in the resin composition for a sealant is preferably from 0.01% by mass to 3% by mass, more preferably from 0.01% by mass to 2% by mass.

<<Method for Preparing Resin Composition for Sealant>>

The method for preparing the resin composition for a sealant according to the disclosure is not particularly limited, and examples thereof include a method of mixing an ethylene/polar monomer copolymer (A), an adhesion-imparting resin (B), a 4-methyl-1-pentene/α-olefin copolymer (C), and a styrene elastomer (D) or other component(s) as necessary by dry blending; and a method of melt-kneading an ethylene/polar monomer copolymer (A), an adhesion-imparting resin (B), a 4-methyl-1-pentene/α-olefin copolymer (C), and a styrene elastomer (D) or other component(s) as necessary with an extruder.

<<Preferred Purposes>>

The resin composition for a sealant according to the disclosure may be applied to various purposes in which the peel strength and the peeling properties with respect to a substrate are required at high levels.

The purpose of the resin composition for a sealant is not particularly limited. The resin composition for a sealant is preferably used as a packaging material.

Examples of the packaging material include a lid material used for packaging foods, toys, stationery, commodities, cosmetics, medicines, quasi-pharmaceutical products, medical tools and the like.

—Multilayered Body—

The multilayered body according to the present disclosure includes a substrate and a sealant layer, and the sealant layer includes the resin composition for a sealant according to the present disclosure.

Since the multilayered body according to the present disclosure includes a sealant layer that includes the resin composition for a sealant according to the present disclosure, the multilayered body exhibits excellent peel strength and peeling properties with respect to a substrate.

<<Substrate>>

The material for the substrate is not particularly limited.

The substrate may have either a single-layer structure or a multilayered structure including two or more layers.

Examples of the substrate include extended or non-extended films made of polyester such as polyethylene terephthalate, polyamide, polypropylene, polyethylene, ethylene/vinyl acetate copolymer, ethylene/unsaturated carboxylic acid ester copolymer, ethylene/unsaturated carboxylic copolymer or an ionomer thereof, ethylene/vinyl alcohol copolymer, paper, an aluminum foil, a film evaporated with a material such as aluminum, silica or alumina, and a film coated with a gas barrier material such as polyvinylidene chloride or polyvinyl alcohol.

The substrate may be subjected to a surface treatment for improving the adhesion with respect to a sealant layer. Specific examples of the surface treatment include a corona treatment, a plasma treatment and an anchor coat treatment.

<<Sealant Layer>>

The sealant layer is a layer including the resin composition for a sealant according to the present disclosure.

The sealant layer may have either a single layer structure or a multilayered structure including two or more layers.

The sealant layer is produced by, for example, melt extrusion using the resin composition for a sealant according to the present disclosure (and an optional component such as an additive).

The content of the resin composition for a sealant according to the present disclosure with respect to the total mass of the sealant layer is preferably 80% by mass or more, more preferably 90% by mass or more.

<<Additional Layer>>

The multilayered body according to the disclosure may have a layer other than the substrate and the sealant layer (hereinafter, also referred to an additional layer).

Examples of the additional layer includes a foamed layer, a metal layer, an inorganic substance layer, a gas-barrier resin layer, an antistatic layer, a hard coat layer, an adhesive layer, an antireflection layer and an antifouling layer.

The multilayered body may have a single additional layer or two or more additional layers in combination. The adhesive layer refers to a layer that is disposed between a pair of layers for improving the adhesion thereof.

The shape of the multilayered body according to the present disclosure is not particularly limited, and may be a sheet shape (i.e., a film shape), for example.

The thickness of the multilayered body according to the present disclosure is not particularly limited, and is preferably from 40 μm to 300 more preferably from 50 μm to 300 further preferably from 50 μm to 200 μm.

The thickness of the sealant layer in the multilayered body is not particularly limited, and is preferably from 1 μm to 500 μm, more preferably from 2 μm to 300 further preferably from 3 μm to 200 μm.

The thickness of the substrate in the multilayered body (when the substrate is multilayered, the total thickness of the layers) is not particularly limited, and is preferably from 4 μm to 300 more preferably from 5 μm to 300 further preferably from 10 μm to 200

<<Preferred Method for Producing Multilayered Body>>

The multilayered body according to the present disclosure may be produced by a known method.

Examples of the production method of the multilayered body include an extrusion lamination method, a coextrusion blow molding method and a coextrusion T-die method. Among these, an extrusion lamination method is preferred.

The multilayered body according to the present disclosure may be subjected to uniaxial or biaxial extension at a desired rate, as necessary.

<<Preferred Purposes of Multilayered Body>>

The purpose of the multilayered body according to the present disclosure is not particularly limited.

Preferred purposes of the multilayered body according to the present disclosure are the same as the preferred purposes of the resin composition for a sealant according to the present disclosure as described above.

—Packaging Material—

The packaging material according to the present disclosure has the multilayered body according to the present disclosure, i.e., a multilayered body including a substrate and a sealant layer including the resin composition for a sealant according to the present disclosure.

The packaging material according to the present disclosure may be suitably used as a lid material, for example.

The packaging material according to the present disclosure exhibits excellent peel strength and peeling properties with respect to a substrate.

The packaging material according to the present disclosure exhibits excellent peel strength and peeling properties especially with respect to a substrate of a container or the like made of an amorphous polyester. Accordingly, the packaging material according to the present disclosure is particularly suitably used as a lid material for a container made of an amorphous polyester.

—Packaging Container—

The packaging container according to the present disclosure has a container main body having an opening and a lid that seals the opening. The lid is formed from the packaging material according to the present disclosure.

Since the packaging container according to the present disclosure has a lid that is formed from the packaging material according to the present disclosure, the lid exhibits excellent peel strength and peeling properties with respect to the container main body having an opening.

The packaging container according to the present disclosure is preferably a packaging container in which the container main body includes an amorphous polyester, more preferably a packaging container in which the container main body includes an amorphous polyethylene terephthalate.

The container main body may include a material other than an amorphous polyester such as an amorphous polyethylene terephthalate, such as polypropylene, polycarbonate or polyvinylidene chloride.

The packaging container according to the present disclosure is suitably used as a packaging container for foods, medicines, industrial materials, commodities, cosmetics or the like, especially suitably used as a packaging container for foods or medicines.

### EXAMPLES

In the following, the present invention is explained by referring to the examples, but the invention is not limited to the examples. The materials, contents, composition ratios, procedures and the like illustrated in the examples may be modified as appropriate without deviating the purpose of the present disclosure. Unless otherwise specified, the “part” refers to “part by mass”.

The MFR of the materials used is measured by the method as described in the Embodiments for Implementing the Invention.

In the following, the “content of ethylene unit” and the “content of vinyl acetate structural unit” refer to the content of structural units derived from ethylene and the content of structural units derived from vinyl acetate, respectively.

Details of the components used for the resin compositions for a sealant of the Examples and the Comparative Examples are as follow.

(Ethylene/Polar Monomer Copolymer (A))

(EVA-1)

Type: ethylene/vinyl acetate copolymer

Content of vinyl acetate structural units (VA content): 10% by mass

MFR (190° C., 2160 g load): 9 g/10 min

(EVA-2)

Type: ethylene/vinyl acetate copolymer

Content of vinyl acetate structural units (VA content): 10% by mass

MFR (190° C., 2160 g load): 3 g/10 min

(EVA-3)

Type: ethylene/vinyl acetate copolymer

Content of vinyl acetate structural units (VA content): 28% by mass

MFR (190° C., 2160 g load): 6 g/10 min

(EVA-4)

Type: ethylene/vinyl acetate copolymer

Content of vinyl acetate structural units (VA content): 19% by mass

MFR (190° C., 2160 g load): 2.5 g/10 min

(Adhesion-imparting resin (B))

Type: alicyclic hydrocarbon resin (ARKON P-115, Arakawa Chemical Industries, Ltd.)

Melting point measured by ring-and-ball method: 115° C.

(4-Methyl-1-Pentene/α-Olefin Copolymer (C))

Type: 4-methyl-1-pentene/propylene copolymer (ABSORTOMER™ EP-1001, Mitsui Chemicals, Inc.)

Density: 840 kg/m³, MFR (230° C., 2160 g load): 10 g/10 min, no melting point, loss tangent (tan δ) peak temperature measured at frequency of 1.6 Hz and temperature elevation rate of 2° C./min: 30° C., loss tangent (tan δ) peak value: 2.7

(Styrene Elastomer (D))

(SEBS-1) Type: maleic acid anhydride-modified styrene-ethylene/butylene-styrene block copolymer (TUFTEC M1943, Asahi Kasei Corporation)

Acid value: 10 mgCH₃ONa/g, MFR (190° C., 2160 g load): 0.5 g/10 min

(SEBS-2)

Type: styrene-ethylene/butylene-styrene block copolymer (KRATON G1657, Kraton Corporation)

MFR (190° C., 2160 g load): 2.8 g/10 min

(Comparative Olefin Copolymer)

Ethylene/1-butene copolymer (TAFMER™ A4085S, Mitsui Chemicals. Inc.) Density: 885 kg/m³, MFR (190° C., 2160 g load): 3.6 g/10 min

(Low-Density Polyethylene: LDPE)

MFR (190° C., 2160 g load): 3.7 g/10 min, density: 917 kg/m³

(Other Components: Additives)

Slip agent (PEG): polyethylene glycol (Nippon Fine Chemical Co., Ltd.) Releasing agent (ELA): erucamide (NOF Corporation)

### Examples 1-6 and Comparative Examples 1-6

—Preparation of Resin Composition for Sealant—

The components in the amounts shown in Table 1 were melted and kneaded at a resin temperature of 180° C. using a monoaxial extruder (diameter: 65 mm, L/D: 26, screw: Dulmadge-type flight screw, Nakatani Kikai K.K.), thereby preparing a resin composition for a sealant.

—Preparation of Test Piece for Evaluation—

A four-layered sheet including a PET layer (12 μm), a PE layer (15 μm), a sealant layer (30 μm) and a silicon PET film (25 μm) was prepared using a single extrusion laminator (diameter: 40 mm, L/D: 32, Tanabe Plastics Machinery Co., Ltd.) under the resin temperature at die exit of 220° C. and the take-over speed of 30 m/min.

Specifically, a sealant layer of a thickness of 30 μm was formed by extruding the resin composition for a sealant from a T-die onto a PE layer of a double-layered substrate including a PET layer (12 μm) and a PE layer (15 μm), and a silicon PET film (thickness: 25 μm, CERAPEEL™, Toray Advanced Film Co., Ltd.) was inserted from the sand substrate side.

The silicon PET film was removed from the four-layered sheet, and was used as a test piece for the evaluation.

—Evaluation—

The following evaluation was performed using the test piece. Containers made of an amorphous polyethylene terephthalate (hereinafter, also referred to as an A-PET container), TAPS92-375 (Takeuchisangyo Corporation) and FP92-375 (Fujinap Co., Ltd.), were used for the evaluation. The results are shown in Table 1. The blank in Table 1 indicates that the corresponding component is not included in the resin composition for a sealant.

<<Evaluation of Peeling Properties>>

The evaluation of peeling properties was performed by the following method.

An A-PET container is placed on a cup holder of a cup sealer (Eshin Pack Industry Co., Ltd.) and a test piece of a size of 10 cm×10 cm was placed on the A-PET container with the sealant layer facing the A-PET container. Then, heat sealing was performed at a heating temperature shown in Table 1, a sealing time of 1 second, and a sealing pressure of 0.1 MPa. After the heat sealing, the A-PET container sealed with the test piece was left to stand for 24 hours at room temperature (23° C.).

Subsequently, the test piece was peeled off by hand from the A-PET container at 23° C., and the existence or non-existence of a peeling sound (zipping) was evaluated according to the following evaluation criteria. In Table 1, “not bonded” refers to that the test piece was not bonded to the A-PET container under the above conditions.

(Evaluation Criteria)

A: a peeling phenomenon associated with zipping does not occur and the test piece is peeled off smoothly.

B: a peeling phenomenon associated with zipping occurs.

<<Evaluation of Peel Strength>>

The peel strength was evaluated by the following method.

An A-PET container is placed on a cup holder of a cup sealer (Eshin Pack Industry Co., Ltd.) and a test piece of a size of 10 cm×10 cm was placed on the A-PET container with the sealant layer facing the A-PET container. Then, heat sealing was performed at a heating temperature shown in Table 1, a sealing time of 1 second, and a sealing pressure of 0.1 MPa. After the heat sealing, the A-PET container sealed with the test piece was left to stand for 24 hours at room temperature (23° C.).

Subsequently, the A-PET container was fixed to a peeling tester (IM-20A, Intesco Co., Ltd.). The test piece was peeled off from the A-PET container at an initial peeling angle of 45° and a peeling rate of 300 mm/min, and the maximum stress was determined as the peel strength (N) with respect to the A-PET container. In Table 1, the “-” indicates that the peel strength was not measured because the test piece was not bonded to the A-PET container.

TABLE 1

| | | VA | | | | | | | | | | | | | | |
|---|---|---|---|---|---|---|---|---|---|---|---|---|---|---|---|---|
| | | con- | | | | | | | | | | | | | | |
| | | tent | | | | | | | | | | | | | | |
| | | (% | MFR | | | | | | | | | | | | | |
| | | by | (g/10 | | Examples | | | | | | Comparative Examples | | | | | |
| | | mass) | min) | Unit | 1 | 2 | 3 | 4 | 5 | 6 | 1 | 2 | 3 | 4 | 5 | 6 |
| Ethylene/polar | EVA-1 | 10 | 9 | part by mass | 35 | 33 | 31 | 29 | 33 | | 100 | 85 | 90 | 85 | 33 | |
| monomer | EVA-2 | 10 | 3 | part by mass | 43 | 40 | 37 | 36 | | | | | | | 40 | |
| copolymer (A) | EVA-3 | 28 | 6 | part by mass | | | | | | 50 | | | | | | |
| | EVA-4 | 19 | 2.5 | part by mass | | | | | 40 | 23 | | | | | | |
| Adhesion-imparting resin (B) | | | 3000 | part by mass | 17 | 17 | 17 | 25 | 17 | 17 | | 15 | | | 17 | 17 |
| 4-methyl-1-pentene/α-olefin | | | 10 | part by mass | 5 | 10 | 15 | 10 | 10 | 10 | | | 10 | 15 | | 10 |
| copolymer (C) | | | | | | | | | | | | | | | | |
| LDPE | | | 3.7 | part by mass | | | | | | | | | | | | 73 |
| Comparative olefin copolymer | | | 3.6 | part by mass | | | | | | | | | | | 10 | |
| Other | ELA | | | part by mass | 0.10 | 0.10 | 0.10 | 0.10 | 0.10 | 0.10 | | | | | 0.1 | 0.1 |
| components | PEG4000 | | | part by mass | 0.05 | 0.05 | 0.05 | 0.05 | 0.05 | 0.05 | | | | | 0.05 | 0.05 |

| Resin composition for sealant | | VA content | % by mass | 7.8 | 7.3 | 6.8 | 6.5 | 10.9 | 18.4 | 10.0 | 8.5 | 9.0 | 8.5 | 7.3 | 0.0 |
|---|---|---|---|---|---|---|---|---|---|---|---|---|---|---|---|
| | | MFR | g/10 min | 14.1 | 14.4 | 14.3 | 26.1 | 13.6 | 13.8 | 9.0 | 20.8 | 8.6 | 8.6 | 10.8 | 11.9 |
| A-PET | Peeling | 160° C. | — | A | A | A | A | A | A | not | B | A | A | B | B |
| container | properties | | | | | | | | | bonded | | | | | |
| Takeuchisangyo | | 180° C. | — | A | A | A | A | A | A | A | B | A | A | B | B |
| TAPS92-375 | Peel | 160° C. | N | 5.9 | 5.4 | 3.5 | 5.7 | 4.6 | 4.4 | — | 4.5 | 1.3 | 0.9 | 6.8 | 2.9 |
| | strength | 180° C. | N | 5.3 | 5.3 | 4.8 | 9.7 | 6.7 | 3.4 | 0.7 | 6.7 | 0.8 | 1.1 | 7.9 | 10.3 |
| A-PET | Peeling | 160° C. | — | A | A | A | A | A | A | not | B | A | A | B | B |
| container | properties | | | | | | | | | bonded | | | | | |
| Fujinap | | 180° C. | — | A | A | A | A | A | A | A | B | A | A | B | B |
| FP-92-375 | Peel | 160° C. | N | 5.0 | 7.3 | 4.3 | 12 | 4.6 | 5.1 | — | 7.4 | 0.8 | 1.3 | 6.5 | 13.8 |
| | strength | 180° C. | N | 7.7 | 4.3 | 6.9 | 8.1 | 4.3 | 3.5 | 2.0 | 6.9 | 0.8 | 2.0 | 7.3 | 14.6 |

### Examples 7-11 and Comparative Examples 7-12

—Preparation of Resin Composition for Sealant—

The resin composition for a sealant having the composition shown in Table 2 and the test piece were prepared in the same manner to Example 1.

With the obtained test piece, the following evaluation was performed.

Containers made of an amorphous polyethylene terephthalate (A-PET container), FP92-375 (Fujinap Co., Ltd.) were used for the evaluation. The results are shown in Table 2. The blank in Table 2 indicates that the corresponding component is not included in the resin composition for a sealant.

<<Evaluation of Peeling Properties>>

Evaluation of the peeling properties was performed by the following method.

An A-PET container is placed on a cup holder of a cup sealer (Eshin Pack Industry Co., Ltd.) and a test piece of a size of 10 cm×10 cm was placed on the A-PET container with the sealant layer facing the A-PET container. Then, heat sealing was performed at a heating temperature shown in Table 1, a sealing time of 1 second, and a sealing pressure of 0.1 MPa. After the heat sealing, the A-PET container sealed with the test piece was left to stand for one day at room temperature (23° C.). Subsequently, the test piece was peeled off by hand from the A-PET container at 23° C., and the existence or non-existence of a peeling sound (zipping) was evaluated according to the following criteria.

(Evaluation Criteria)

A: zipping does not occur.

B: a slight degree of zipping occurs.

C: a significant degree of zipping occurs.

<<Evaluation of Peel Strength>>

The peel strength was evaluated by the following method.

An A-PET container is placed on a cup holder of a cup sealer (Eshin Pack Industry Co., Ltd.) and a test piece of a size of 10 cm×10 cm was placed on the A-PET container with the sealant layer facing the A-PET container. Then, heat sealing was performed at a heating temperature shown in Table 1, a sealing time of 1 second, and a sealing pressure of 0.1 MPa. After the heat sealing, the A-PET container sealed with the test piece was left to stand for one day at room temperature (23° C.). Subsequently, the A-PET container was fixed to a peeling tester (IM-20A, Intesco Co., Ltd.) and the test piece was peeled off from the A-PET container at an initial peeling angle of 45° and a peeling rate of 300 mm/min, and the maximum stress (N) was measured.

The arithmetic average value of the five measured values of the maximum stress (N) was determined as the peel strength (N) with respect to the A-PET container.

TABLE 2

| | | | Examples | | | | | Comparative Examples | | | | | |
|---|---|---|---|---|---|---|---|---|---|---|---|---|---|
| | | Unit | 7 | 8 | 9 | 10 | 11 | 7 | 8 | 9 | 10 | 11 | 12 |
| Ethylene/polar | EVA-1 | part by mass | 32 | 31 | 30 | 31 | 30 | 100 | 85 | 90 | 85 | 33 | |
| monomer | EVA-2 | part by mass | 40 | 39 | 38 | 39 | 38 | | | | | 40 | |
| copolymer (A) | | | | | | | | | | | | | |
| Adhesion-imparting resin | | part by mass | 17 | 17 | 17 | 17 | 17 | | 15 | 0 | 0 | 17 | 17 |
| (B) | | | | | | | | | | | | | |
| 4-methyl-1-pentene/α-olefin | | part by mass | 10 | 10 | 10 | 10 | 10 | | | 10 | 15 | | 10 |
| copolymer (C) | | | | | | | | | | | | | |
| Styrene | SEBS-1 | part by mass | 1 | 3 | 5 | | | | | | | | |
| elastomer (D) | SEBS-2 | part by mass | | | | 3 | 5 | | | | | | |
| LDPE | | part by mass | | | | | | | | | | | 73 |
| Comparative olefin | | part by mass | | | | | | | | | | 10 | |
| copolymer | | | | | | | | | | | | | |
| Other | ELA | part by mass | 0.1 | 0.1 | 0.1 | 0.1 | 0.1 | | | | | 0.1 | 0.1 |
| components | PEG4000 | part by mass | 0.05 | 0.05 | 0.05 | 0.05 | 0.05 | | | | | 0.05 | 0.05 |
| Total | | part by mass | 100.15 | 100.15 | 100.15 | 100.15 | 100.15 | 100.00 | 100.00 | 100.00 | 100.00 | 100.15 | 100.15 |
| VA content | | % by mass | 7.2 | 7.0 | 6.8 | 7.0 | 6.8 | 10 | 8.5 | 9.0 | 8.5 | 7.3 | 0 |
| MFR | | g/10 min | 14 | 13.4 | 13.4 | 14.6 | 13.3 | 9 | 20.8 | 8.6 | 8.6 | 10.8 | 11.9 |
| Peeling properties | 180° C. | — | B | B | B | A | A | A | B | A | A | C | C |
| Peel strength (N) | 180° C. | N | 12.6 | 12.9 | 13.4 | 12.8 | 7.4 | 1.0 | 6.5 | 1.9 | 0.9 | 8.0 | 11.1 |

As shown in Table 1 and Table 2, the resin compositions for a sealant of the Examples exhibit favorable peel strength and peeling properties with respect to an A-PET container including an amorphous polyester, as compared with the resin compositions for a sealant of the Comparative Examples.

The disclosures of Japanese Patent Application Nos. 2019-064698 and 2019-168513 are herein incorporated entirely by reference. All publications, patent applications, and technical standards mentioned in this specification are herein incorporated by reference to the same extent as if each individual publication, patent application, or technical standard was specifically and individually indicated to be incorporated by reference.

1-13. (canceled)

14. A packaging material, comprising a multilayered body, the multilayer body comprising a substrate and a sealant layer, the sealant layer comprising a resin composition for a sealant,
the resin composition comprising an ethylene/polar monomer copolymer (A), an adhesion-imparting resin (B) and a 4-methyl-1-pentene/propylene copolymer (C), a content of the 4-methyl-1-pentene/propylene copolymer (C) being from 1% by mass to 20% by mass with respect to a total mass of the resin composition for a sealant, and the 4-methyl-1-pentene/propylene copolymer (C) having a content of structural units derived from propylene of 25% by mole or more and 40% by mole or less with respect to a total structural units of the 4-methyl-1-pentene/propylene copolymer (C).

15. The packaging material according to claim 14, further comprising a styrene elastomer (D).

16. The packaging material according to claim 15, wherein the styrene elastomer (D) comprises at least one selected from the group consisting of a styrene-ethylene/butylene block copolymer (SEB), a styreneethylene/butylene-styrene block copolymer (SEB S) and a styrene-ethylene/propylenestyrene block copolymer (SEPS).

17. The packaging material according to claim 15, wherein a content of the styrene elastomer (D) is from 1% by mass to 15% by mass with respect to a total mass of the resin composition for a sealant.

18. The packaging material according to claim 14, wherein the 4-methyl-1-pentene/propylene copolymer (C) has a melting point of less than 110° C. or does not have a melting point.

19. The packaging material according to claim 14, wherein the ethylene/polar monomer copolymer (A) is an ethylene/vinyl acetate copolymer.

20. The packaging material according to claim 19, wherein the ethylene/vinyl acetate copolymer has a content of structural units derived from vinyl acetate of from 1% by mass to 30% by mass.

21. The packaging material according to claim 14, wherein the resin composition for a sealant has a melt mass flow rate (JIS K7210-1999, 190° C., 2160 g load) of from 1 g/10 min to 100 g/10 min.

22. A lid material, comprising the packaging material according to claim 14.

23. A packaging container, comprising a container main body having an opening and a lid that seals the opening, the lid being formed from the packaging material according to claim 14.

24. The packaging container according to claim 23, wherein the container main body comprises an amorphous polyester.
